(19) United States
(12) Patent Application Publication
(10) Pub. No.: US 2010/0161856 A1
(43) Pub. Date: Jun. 24, 2010

(54) USB AUDIO AND MOBILE AUDIO SYSTEM USING USB AUDIO CONTROLLER

(75) Inventor: Rong-Hwa Ding, Taipei County (TW)

Correspondence Address: JIANQ CHYUN INTELLECTUAL PROPERTY OFFICE, 7 FLOOR-1, NO. 100, ROOSEVELT ROAD, SECTION 2, TAIPEI, 100, TW

(73) Assignee: SOLID STATE SYSTEM CO., LTD., Hsinchu (TW)

(21) Appl. No.: 12/342,019

(22) Filed: Dec. 22, 2008

(51) Int. Cl. G06F 3/00

(52) U.S. Cl. 710/62

(57) ABSTRACT

A USB audio controller includes an USB interface unit, an audio interface unit, a storage interface unit, and a processing unit. The USB interface unit is used to connect to a USB bus for communicating with a host by a communication information. The audio interface unit is used to connect to at least one audio device for communicating with an audio signal. The storage unit is used to connect to a memory unit for communicating storage information. The processing unit is for processing the communicating information and audio signal.

### BACKGROUND OF THE INVENTION

1. Field of Invention

The present invention relates to audio processing. More particularly, the present invention relates to a dual mode audio controller.

2. Description of Related Art

Universal serial bus (USB) is well known in signal communication for transmitting data. Computer system and various peripheral devices have widely adopted the USB port for transmitting data. An USB audio device can be used for PC peripheral applications, such as USB VOIP (voice over internet protocol) or USB headphone set. After the USB audio device is connected to the USB host, it takes the role of PC sound card for audio signal input and output. Depending on the actually design and operation, the USB audio device can automatically replace the PC sound card. For USB VOIP application, users can have voice communication through internet. On the other side, digital audio player, such as MP3 player, is often connected to the USB port of the computer system for downloading the music into the digital audio player where the audio controller works as an USB storage function.

However, the conventional design uses various units in separate operation. It causes higher system cost and may be not easy in operation. The operation has to be based on the computer system, to which the audio device is connected. How to improve the application, particularly in mobile manner, is one of the issues in consideration.

### SUMMARY OF THE INVENTION

The invention provides a dual mode audio controller. Such controller can be operated as a USB audio sound device and a USB storage device at the same time when it is connected to an USB host. When such device is disconnected from the USB host, it works as a mobile audio player when a battery set is attached. Most function resources; such as CPU unit, storage unit, audio ADC, audio DAC, external earphone, and external microphone are shared in both modes so that a very cost saving solution can be achieved. In addition, add-on function like USB VOIP dialog hardware recording can be achieved with this dual mode audio controller scheme. Such function removes the complicated software effort needed in USB host in prior art.

A universal serial bus (USB) audio controller includes an USB interface unit, an audio interface unit, a storage interface unit, and a processing unit. The USB interface unit is used to connect to a USB bus for communicating with a USB host. The audio interface unit can be used to connect to at least one audio device for audio signal. The storage interface unit is used to communicate with an external data storage unit. The processing unit is for processing the communicating information and the audio signal, and is for processing a USB audio device class protocol with respect to the USB audio device and a USB storage device class protocol with respect to the USB storage unit at the same time when the USB interface unit is connected to a USB host. The processing unit is also for processing an audio playback function with an audio source from the storage unit or for processing an audio record function with an audio source from the audio device when the USB interface unit is disconnected from the USB host. Wherein, the USB audio device class protocol and USB storage device class protocol communicates between the USB host and the USB audio device. Wherein, the audio playback or recording function communicates between the storage interface unit and the audio interface unit.

It is to be understood that both the foregoing general description and the following detailed description are exemplary, and are intended to provide further explanation of the invention as claimed.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is a block diagram, schematically illustrating a prior art implement the audio device based on USB protocol.

FIG. 2 is a block diagram, schematically another prior art for dual-mode USB audio device in consideration.

FIG. 3 is a block diagram, schematically illustrating a USB audio controller, according to an embodiment of the invention.

FIG. 4 is a block diagram, schematically illustrating a USB audio mode operation, according to an embodiment of the present invention.

FIG. 5 is a block diagram, schematically illustrating a mobile audio mode operation, according to an embodiment of the present invention.

FIG. 6 is a block diagram, schematically illustrating an operation of the USB audio controller, according to an embodiment of the present invention.

### DESCRIPTION OF THE PREFERRED EMBODIMENTS

Several embodiments are provided to describe the inventions. However, the invention is not just limited to the embodiments. Also and, the provided embodiments can be properly combined to each other.

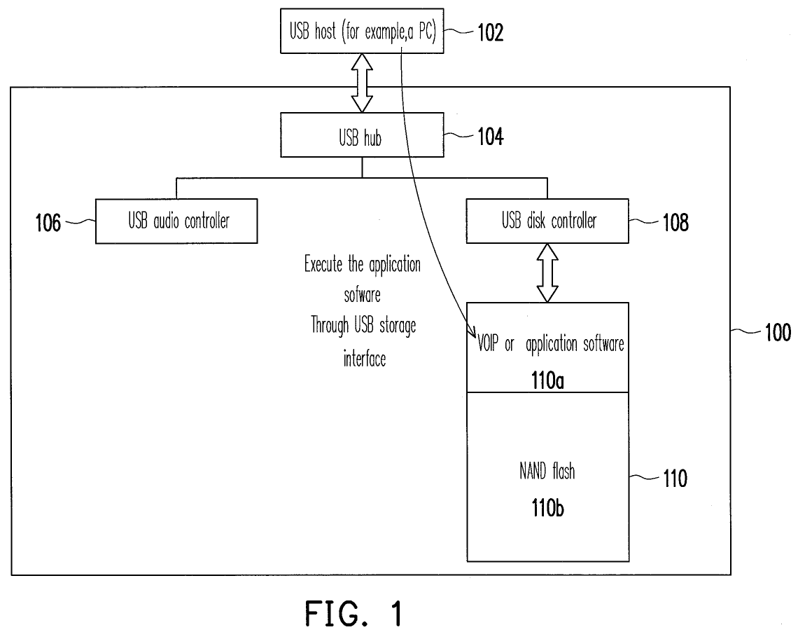

To have USB VOIP or USB audio application mobilized with the USB audio device, some considerations have been taken. FIG. 1 is a block diagram, schematically illustrating a preliminary aspect to implement the audio device based on USB protocol. In FIG. 1, a USB audio device 100 includes a USB hub 104 connects with one USB audio controller 106 and another USB disk controller 108. The USB disk controller 108 is connected to a storage unit 110, which has stored VOIP or other application software in the storage space 110a, and another is unused storage space 110b which can be used in later operation for storing some additional information. In addition, other software, such as voice mail application software, can be stored in 110a, and the USB storage unit 110 which can be of NAND flash. The USB hub 104, the USB audio controller 106, the USB disk controller 108, and a storage unit 110 are integrated in one USB device 100. When the USB device 100 is attached to the USB host 102, the USB VOIP or the audio application software stored in the storage space 110a, such as voice mail software, or VOIP recording software, can be executed from the USB storage unit 110 via the USB disk controller 108. The audio playback and the recording are operated via the USB audio controller 106 which can include audio DAC for playback and audio ADC for recording. With such device, the USB VOIP or audio related application software stored in storage space 110a is not needed to be pre-installed in the computer in advance before the use though the operation is running on the host.

However, the device in FIG. 1 may increase the system cost since three different ICs of controllers are needed in this device. In addition, in order to have VOIP dialog recorded into digital file, one manner is using software, which is running in the USB host, such as computer system or personal computer. Such software captures the audio signals from other application software and saves the captured audio data into the host storage unit, such as a hard disk or a flash memory in USB disk storage. The file recording application is based on software application, and then is very complicated since the software developers need to deal different operating systems and many different kinds of VOIP software which are developed by different VOIP providers.

Another possibility for such two-way recording is adding external ADC in the analog domain. However, how to store the converted audio data into the memory unit has become a problem since most memory units, such as hard disk, flash memory or memory card, cannot be directly connected to the ADC.

This kind of USB audio device is not proper in operation when the device is not connected to a USB host. It causes a waste for the resource in such device. Usually, the audio ADC, DAC, earphone unit, microphone, and storage media have constituted most parts of the key components for a mobile audio player.

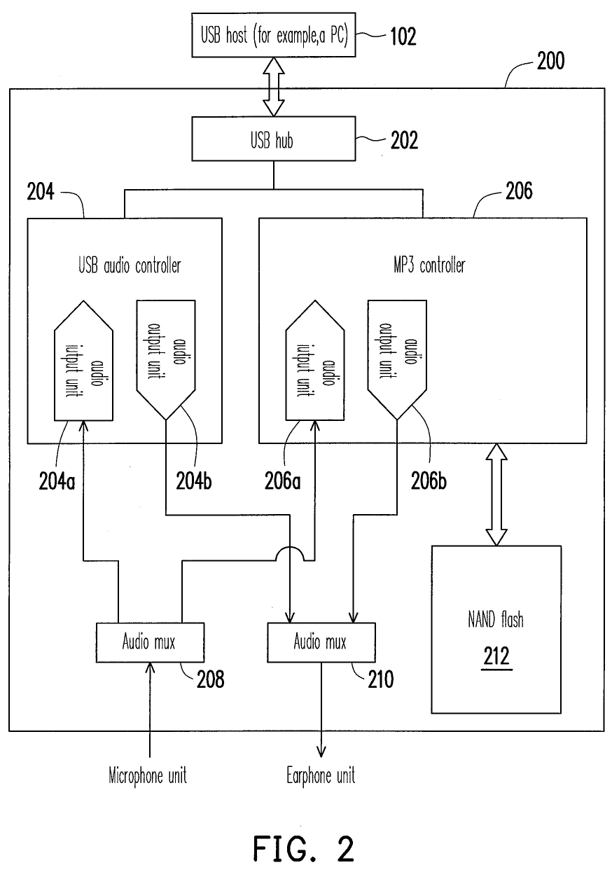

In order to make the arrangement work as a mobile audio device, one of possibilities is shown. FIG. 2 is a block diagram, schematically another design of dual-mode USB audio device in consideration. The dual-mode USB audio device 200 works as an USB audio device and USB storage unit when it is connected to a USB host 102. The function of USB audio is provided from the USB audio controller 204. The USB storage function is provided from the mobile audio controller 206, such as MP3 controller 206. The dual-mode USB audio device 200 also works as an audio player when it is disconnected from the USB host 102 and a battery set is providing power supply. In this mode, the mobile audio controller 206 playbacks the music stored in the storage unit 212 and the USB audio controller 204 is not working.

Usually, the USB audio controller 204 includes an audio input unit 204a having ADC and an audio output unit 204b having DAC. The mobile audio controller 206 also includes an audio input unit 206a having ADC and an audio output unit 206b having DAC, as well. An audio multiplexer 208 is coupled to input units 204a, 206a of the USB audio controller 204 and the mobile audio controller 206 in selection for input by, for example, microphone unit. Another audio multiplexer 210 is also coupled to output units 204b, 206b of the USB audio controller 204 and the mobile audio controller 206 in selection for output to, for example, earphone unit. The storage unit 212, such as the NAND flash stores the audio information for playing and allows to write-in additional audio information.

In the structure of FIG. 2, extra analog audio signal switches by the audio multiplexers 208 and 210 are added for the signal selection. The system cost for such device is high due to many extra units needed, for example, duplicated ADC and DAC, extra audio switches. For some audio controllers, which do not include ADC or DAC, still need external ADC and DAC before the audio switches. To record the USB audio data stream into digital files when this device 200 is attached to a USB host 102, it needs software effort in the USB host 102.

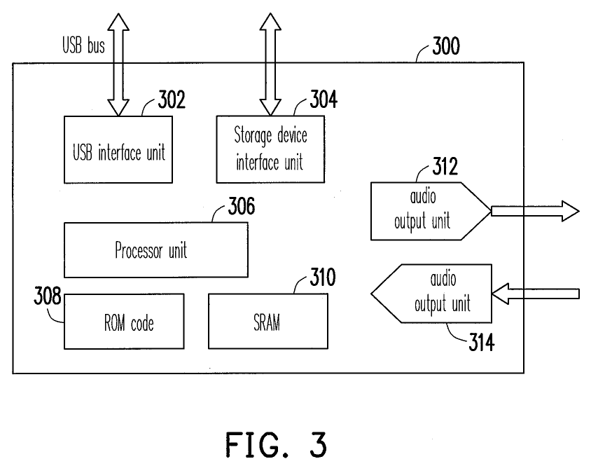

The present invention proposes a dual-mode USB audio controller in more function with low system cost. FIG. 3 is a block diagram, schematically illustrating a USB audio controller, according to an embodiment of the invention. The USB audio controller 300 includes, for example, a USB interface unit 302, a storage device interface unit 304, a processor unit 306, and an audio interface unit having an audio output unit 312 and an audio input unit 314, coupled together. The processing unit 306 may need to have the ROM code 308, and the memory device 310, such as SRAM, for working memory for any need. The processing unit 306 processes the input signals and outputs the processed signals to the corresponding interface unit. Usually, the processor unit 306 has at least one processor. For example, the processor unit 306 can have, for example, DSP or MCU. However, processor unit 306 can also have multiple processors, for example, having both the DSP and MCU. In other words, the processor unit 306 has to be implemented with all the processors in need for adapting various operations.

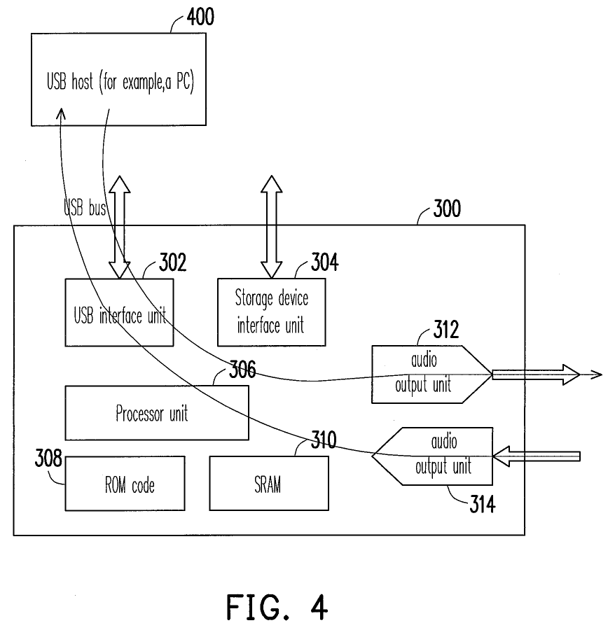

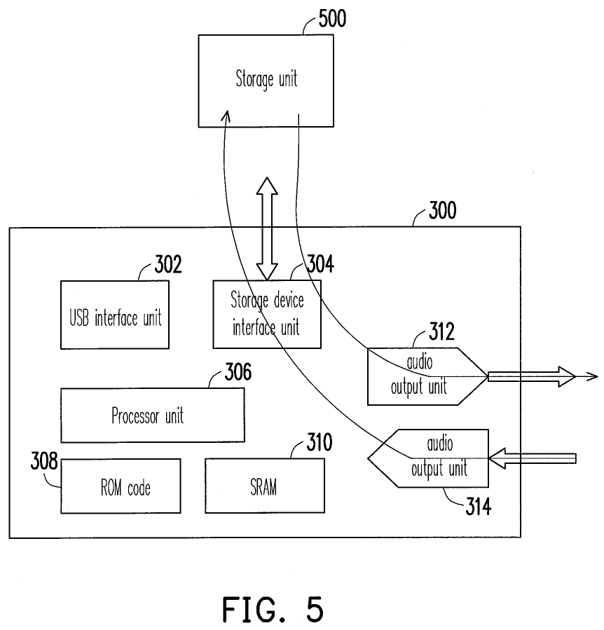

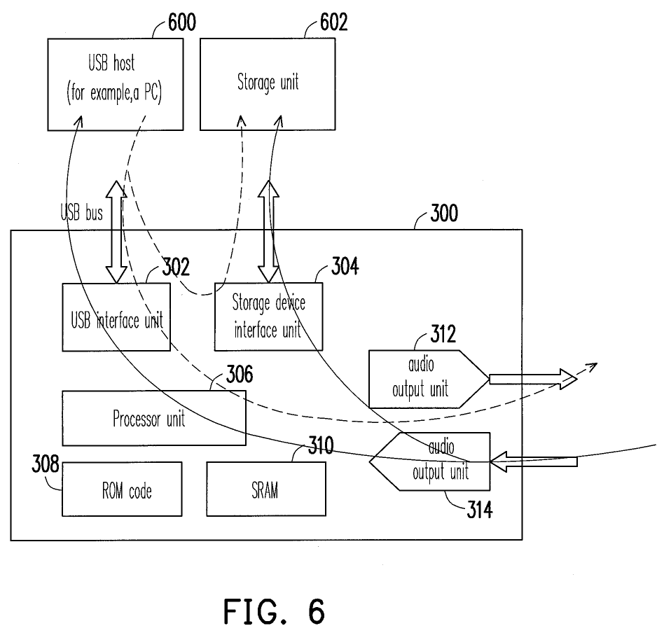

The operation is in two modes of USB audio mode or mobile audio mode. FIG. 4 is a block diagram, schematically illustrating a USB audio mode operation, according to an embodiment of the present invention. The USB interface 302 is activated when this USB audio controller 300 is connected to a USB host 400 via the USB bus. In this mode, a processor unit 306 processes the USB protocol and informs to the USB host 400 that the controller 300 can operate as a USB audio device and a USB storage unit at the same time, also called a USB composite device. The storage device interface unit 304 can be externally connected to a storage unit 500 (shown in FIG. 5), such as NAND flash, a memory card, a hard disk, or other kind of non-volatile memory unit. The USB host 400 can read, write, move, delete, copy, or execute files, such as VOIP files, in the storage unit 602 as to be described in FIG. 6.

In USB audio mode operation, user can listen to the audio playback from the USB host 400 via the audio output unit 312 having internal DAC or external DAC unit and record back to the USB host 400 via the audio input unit 314 having internal ADC or external ADC unit. When the controller 300 is operated together with battery set and USB is not connected, it works as a mobile audio player in mobile audio mode. User can listen to the audio files stored in the storage unit via the audio output unit 312, or record to the storage unit via the audio input unit 314.

FIG. 5 is a block diagram, schematically illustrating a mobile audio operation mode, according to an embodiment of the present invention. In FIG. 5, actually, the audio signals are communicating between the storage unit 500 and the audio output unit 312 or the audio input unit 314 of the audio interface unit, without need of the USB interface. Herein the storage unit 500 may be external or embedded in the controller. Further, the memory unit 308 may be serving as the embedded storage unit for storing the audio information.

In this integrated circuit chip, the processor unit 306, the audio output unit 312, and the audio input unit 314 are activated in both two modes. And the external earphone speaker and microphone (not shown) may be connected to the audio output unit 312 and the audio input unit 314, respectively, used in both modes. Thus this controller is very economic. It can work in two different functions and shares most resources in two different applications.

The audio output unit 312 can be a digital interface with external DAC, or embedded DAC with earphone amplifier for direct earphone connection. The audio input unit 314 can be a digital interface with external ADC, or an embedded ADC with microphone pre-amplifier for direct connection to microphone.

FIG. 6 is a block diagram, schematically illustrating an operation of the USB audio controller, according to an embodiment of the present invention. In FIG. 6, actually, various application routes can be set up. As the combination of FIG. 4 and FIG. 5, the separate function can be achieved. The additional function can be even more achieved in USB audio mode. The host 600 can communicate with the external audio source apparatus, such as speaker and microphone, which are connected to the audio output unit 312 and the audio input unit 314. In alternative choice, the storage unit 602, as shown as the storage unit 500 in FIG. 5 and the storage unit 602 in FIG. 6, can communicate with the external audio source apparatus, such as microphone and speaker. In addition, the host 600 can also communicate with the storage device interface unit 304 when the USB audio controller 300 is connected to the host 600 and the storage unit 602. Further for example, when the audio information is input from the audio input unit 314 to the host 600, the audio information can be store on the storage unit 602. Alternatively, when the host 600 provides the audio information to the USB audio controller 300 at the audio output unit 312, the audio information can also be stored in the storage unit 602.

In other words, one common application for this composite USB device is for USB VOIP dialog recording application. User talks to the audio input unit 314 and listens to audio data via the audio output unit 312. Both the USB audio stream data go through this controller can be redirected to the storage unit so the two-way talking can be recorded into digital file form without degrade. This recording operation can be processed without additional software effort from the USB host CPU for running recording software. Thus such operation can remove the software developing effort needed for interfacing different operating systems (Windows XP, Mac OS X, Linux, etc) and different VOIP applications (Skype, Microsoft MSN, Yahoo MSN, Google talk, etc). In one embodiment simple enable or disable control signals sent from the USB host software are used to control such action.

Such audio recording can be applied on other applications besides USB VOIP application; for example, language learning, audio signal mixing, etc.

VOIP application software can be stored in the storage unit 602 or the ROM code 308 in FIG. 6, so that user can execute the VOIP software without any pre-installation of such software in the computer. Here, the storage unit 602 may be also embedded in the USB audio controller 300 in alternative manner. User can carry this USB composite device 300 connected with storage unit 602 and use computer for VOIP application at other places easily without pre-installation for such VOIP software in other computers.

What is claimed is:

1. A universal serial bus (USB) audio controller, comprising:
an USB interface unit, used to connect to a USB bus for communicating with a USB host by a communication information;
an audio interface unit, used to connect to at least one audio device for communicating with an audio signal;
a storage interface unit, used to communicate with an external storage unit by a storage information; and
a processing unit, having at least one processor, for processing the communicating information and the audio signal, and for processing a USB audio device class protocol with respect to a USB device class definition for the audio device and a USB storage device class protocol with respect to a USB mass storage class at the same time when the USB interface unit is connected to a USB host, and for processing an audio playback function with an audio source from the storage unit when the USB interface unit is disconnected from the USB host,
wherein the USB audio device class protocol and USB storage device class protocol communicate between the USB host and the USB audio device,
wherein the audio playback function communicates between the storage interface unit and the audio interface unit.

2. The USB audio controller of claim 1, wherein the audio signal comprises an input audio signal and an output audio signal, and the audio interface unit comprises:
one audio input unit for receiving the input audio signal; and
one audio output unit, for outputting the output audio signal.

3. The USB audio controller of claim 2, wherein the audio input unit comprises one or multiple analog-to-digital converter (ADC) circuit, or the audio output unit comprises one or multiple digital-to-analog converter (DAC) circuit.

4. The USB audio controller of claim 2, wherein the audio input unit comprises at least one analog-to-digital converter (ADC) circuit and the audio output unit comprises at least one digital-to-analog converter (DAC) circuit.

5. The USB audio controller of claim 1, further comprising a memory unit for at least storing an operation code, used by the processing unit in processing.

6. The USB audio controller of claim 1, further comprising a memory unit for at least storing an processing temporary data, used by the processing unit in processing.

7. The USB audio controller of claim 1, wherein the processing unit comprises a capability to decompress an audio compressed format.

8. The USB audio controller of claim 1, wherein a nonvolatile memory unit is embedded in the controller to communicate with the storage interface unit.

9. The USB audio controller of claim 1, wherein an audio signal inputs from the audio device via the audio interface unit to the storage unit via the storage interface unit for audio recording function when the audio controller is disconnected to the USB host.

10. The USB audio controller of claim 1, wherein the storage information is processed as an audio signal, wherein the audio signal outputs to the audio device via the audio interface unit from the USB host when the audio controller is connected to the USB host.

11. The USB audio controller of claim 1, wherein the storage information is processed as an audio signal, wherein an input audio signal inputs from the audio device via the audio interface unit to the USB host when the audio controller is connected to the USB host.

12. The USB audio controller of claim 1, wherein the storage information comprises:
a first storage information, wherein the first storage information is processed as an audio signal for outputting to the audio device via the audio interface unit from the USB host when the audio controller is connected to the USB host; and
a second storage information, wherein an input audio signal inputs from the audio device via the audio interface unit is processed as the second storage information for external storage and the input audio signal is also transmitted to the USB host when the audio controller is connected to the USB host.

13. The USB audio controller of claim 1, wherein the storage unit communicates with the USB host via the USB interface unit and the storage device interface unit.

14. The USB audio controller of claim 1, wherein the storage device interface unit receives an audio signal from both the USB interface unit and the audio interface unit after the processing unit processes the audio signal.

15. The USB audio controller of claim 1, wherein the storage unit communicates with the USB host via the USB interface unit and the storage device interface unit wherein a software stored in the storage unit is executed by the USB host when the USB controller is connected to the USB host.

16. The USB audio controller of claim 1, wherein the USB interface unit, the audio interface unit, the storage interface unit, and the processing unit are integrated as a single integrated circuit chip.
